(19) United States
(12) Patent Application Publication
(10) Pub. No.: US 2014/0093219 A1
(43) Pub. Date: Apr. 3, 2014

(54) Multiple Data Source Aggregation for Efficient Synchronous Multi-Device Media Consumption

(71) Applicant: NoiseToys Inc., San Francisco, CA (US)

(72) Inventor: Mehul Trivedi, San Francisco, CA (US)

(73) Assignee: NoiseToys Inc., San Francisco, CA (US)

(21) Appl. No.: 14/039,258

(22) Filed: Sep. 27, 2013

Related U.S. Application Data
(60) Provisional application No. 61/707,046, filed on Sep. 28, 2012.

(51) Int. Cl. H04N 21/242

(52) U.S. Cl. CPC H04N 21/242
USPC 386/201

(57) ABSTRACT

Methods and systems for efficient synchronous playback among a group of devices using both locally and remotely stored data from one or more content providers are provided. A content identification and matching system can be used to identify local content on the group of devices and match the local content to content available from remotely available libraries. A control and content delivery system can be used to allow multiple devices to synchronously play content from local or remote sources as available.

### PRIORITY CLAIM

This application claims the benefit of priority of U.S. Provisional Patent Application Ser. No. 61/707,046, titled “System and Method for Multiple Data Source Aggregation for Efficient Multi-User Media Consumption,” which is incorporated herein by reference for all purposes.

### FIELD

The present disclosure relates to media consumption and more particularly to systems and methods for providing multiple data source aggregation for efficient synchronous multi-device media consumption.

### BACKGROUND

Computing devices, such as smartphones, tablets, digital music players, laptops, desktops, smart televisions, home theater systems, and other computing devices, can be used to provide media content, such as music, videos, documents, images, and other media content, to users. The media content can be accessible by the computing devices from many different media content sources. For instance, the media content can be stored locally in a memory (e.g. local storage) of a computing device. The media content can be stored at a remote computing device that can be accessed over a network or other suitable link. In addition, a computing device can stream or otherwise access content stored at a remote computing device (e.g. a web server) associated with a content provider that is accessible via the Internet.

In certain cases, it can be desirable to synchronously present media content on a plurality of different computing devices. For instance, it can be desirable to play music on a first computing device synchronously with a second computing device. The plurality of computing devices may have access to different content sources storing the media content. A system and method that can provide for efficient synchronous presentation of media content across a plurality of computing devices using media content stored across multiple different content sources would be useful.

### SUMMARY

Aspects and advantages of the invention will be set forth in part in the following description, or may be obvious from the description, or may be learned through practice of the invention.

One example aspect of the present disclosure is directed to a computer-implemented method for providing synchronous playback of media content across a plurality of media devices. The method includes identifying, by one or more computing devices, a plurality of media devices for synchronous media playback and identifying, by the one or more computing devices, a media object accessible by the plurality of media devices for synchronous playback. The method further includes notifying, by the one or more computing devices, each of the plurality of media devices to play the media object and synchronizing, by the one or more computing devices, playback of the media object among the plurality of media devices. Each of the plurality of media devices can be configured to identify a media content source for accessing the media object for synchronous playback of the media object.

Another example aspect of the present disclosure is directed to a system for providing synchronous playback of media content across a plurality of media devices. The system can include one or more processors and one or more computer-readable media. The system can further include a content identifier module implemented by the one or more processors. The content identifier module is configured to identify a media object accessible by one or more of a plurality of media devices. The system can further include a control module implemented by the one or more processors. The control module can be configured to notify each of the plurality of media devices to play the media object. The control module can be further configured to manage synchronization of playback of the media object across the plurality of media devices.

Yet another exemplary aspect of the present disclosure is directed to a media device. The media device can include a media output device and one or more tangible, non-transitory computer-readable media storing computer-readable instructions that when executed by one or more processors cause the one or more processors to perform operations. The operations include identifying a media object to be played synchronously with a remote media device and notifying the remote media device to play the media object. The operations can further include identifying a media content source for accessing the media object by the media device and synchronizing playback of the media object over at least the media output device among the media device and the remote media device.

Other exemplary aspects of the present disclosure are directed to systems, apparatus, non-transitory computer-readable media, devices, and user interfaces for providing synchronous media presentation across a plurality of devices.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an overview of a system according to example embodiments of the present disclosure;

FIG. 2 depicts a flow diagram of a method according to example embodiments of the present disclosure; and

FIG. 3 depicts a block diagram of a computing environment according to example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

### Overview

Generally, example aspects of the present disclosure are directed to the efficient synchronous playback of media content among a group of media devices using both locally and remotely stored data from multiple content sources. The media content can be music, videos, documents, images, and other suitable media content. The media content can include one or more media objects (e.g. a song, a file, a track, a video, a document, a digital image), which can represent a discrete aspect of the media content. According to aspects of the present disclosure, media content can be efficiently played back among a plurality of media devices. The media devices can be any suitable device for playing media, including computing devices such as smartphones, tablets, digital music players, laptops, desktops, smart televisions, home theater systems and other suitable devices capable of playing a media object. Each of the media devices can have access to the media content from a different content source (e.g. a local library, a remote library, a content delivery service, etc.). The media content can be played on each media device using a content source accessible by the media device.

For instance, a group of media devices on which synchronous playback of media content can be defined. Media content accessible by the group of media devices can be identified and matched to one or more remote media content libraries. The media devices can be notified on what media content to play. Synchronous playback among the media devices can be performed using one or more control signals. The media content played on each media device can be accessed using the most efficient available content source available to the media device.

More particularly, a group of media devices for synchronous media playback can be identified. Media content available to or accessible by the local devices can then be determined. The media content accessible by the local devices can include content in local media libraries stored locally at each of the media devices as well as media content stored in remote media libraries accessible over a network. The media content accessible by the local devices can also include media content accessible via a content delivery network (e.g. a streaming service).

In one implementation, local media content on the media devices can be identified. Identifiers associated with the local media content can be determined based on metadata associated with the media content, user tags, fingerprint analysis of the media content, or other data associated with the media content. The identifiers can be matched with a reference database of identifiers to identify media content that is available to the media device via a remote library and/or via a content delivery service.

The media devices can be notified of a desired media object to play. The notification can be provided by one of the media devices in the group or by a remote computing device in communication with the media devices, for instance, over a network (e.g. the Internet). The media devices can then determine, using the specified identifiers, if that content is accessible, either locally, remotely, or through a connected content service. If not, a copy can be provided using a content delivery network associated with the system.

Using a server component, the media devices can then all be synchronized to a single reference, allowing for the group to present the media concurrently. The server component can include or can be implemented by either one of the plurality of media devices in the group or by an external remote computing device (e.g. a web server). This allows a group of media devices to present media concurrently, but using the most suitable data source specific to each device, including but not limited to a local copy, a remotely stored version of a personal copy, or a streamed version from an on-demand service.

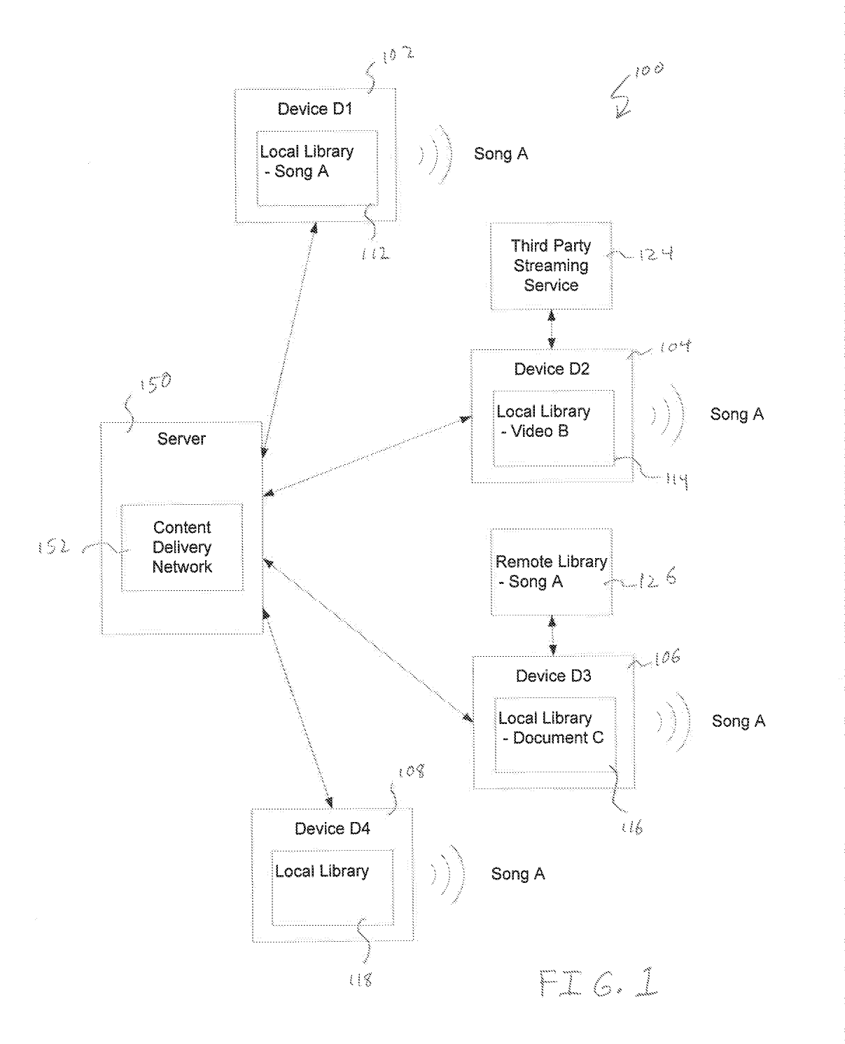

FIG. 1 depicts an overview of a system 100 for providing synchronous playback across a plurality of media devices according to example aspects of the present disclosure. As illustrated, the system 100 includes a plurality of media devices including Device D1 102, Device D2 104, Device D3 106, and Device D4 108. The media devices 102, 104, 106, and 108 can form a group of media devices across which synchronous playback is desired. Each device 102, 104, 106, and 108 can be configured to identify media content accessible on the device. For example, device D1 102 can identify a local file Song A in its local library 112. Device D2 104 can identify local file Video B in its local library 114. Device D2 104 can also have access to a third-party on-demand streaming music service 124. Device D3 106 can identify local file Document C in its local library 116. Device D3 106 can also have access to a remote library 126, for instance, over a network. The remote library can include the file Song A. Device D4 108 can have no identified local files.

The system 100 can further include a server 150 configured to coordinate synchronous playback among the group of media devices 102, 104, 106, and 108. The server 150 can be implemented by a remote computing device (e.g. a web server). Alternatively, the server 150 can be implemented by one of the media devices 102, 104, 106, or 108.

Device D1 102 can notify the server 150 to play Song A concurrently with device D2 104, device D3 106, and device D4 108. The server 150 can notify all connected devices to play Song A. Device D1 102 uses local copy of Song A to play. Device D2 104 uses identifiers for Song A to find matching song from third party on-demand streaming service 124. Device D3 106 streams the remotely stored copy of Song A.

Device D4 108 has no privately accessible copy of Song A. Device 108 can send a request for Song A to a content delivery network 152 implemented by the server 150. The content delivery network 152 can provide access (e.g. via streaming) to Song A to the device D4 108 to play concurrently with device D1 102, device D2, 104, and device D3 106.

The server 150 can manage the synchronous playback of Song A across the plurality of media devices 102, 104, 106, and 108. For instance, the server 150 can send a control signal to control playback time of Song A on each of the plurality of media devices 102, 104, 106, and 108. The server 150 can optionally provide additional control parameters, such as specifying the start point, length of playback, etc.

### Flow Diagram of Example Computer-Implemented Method

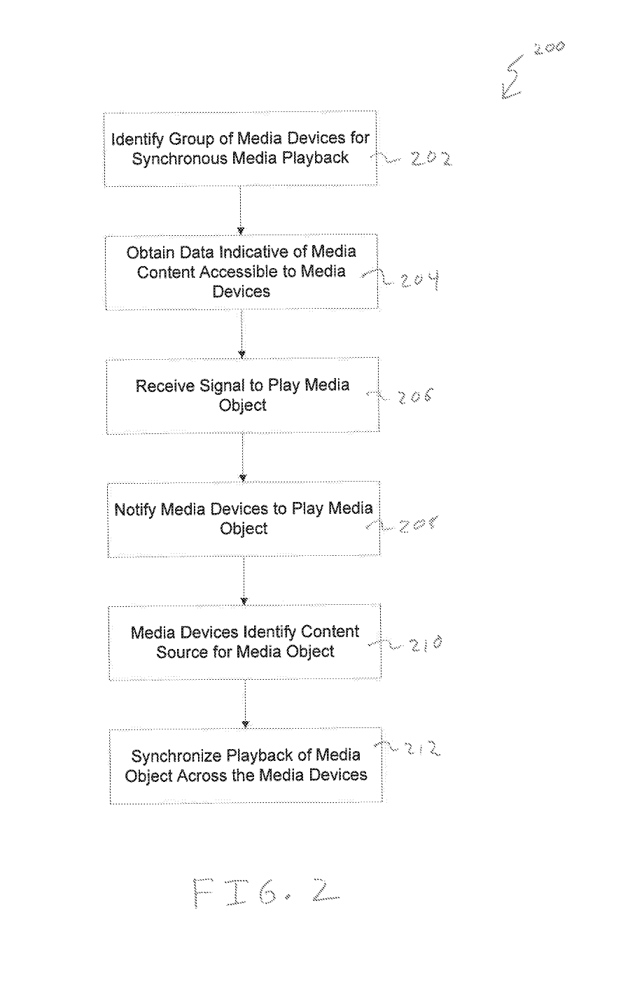

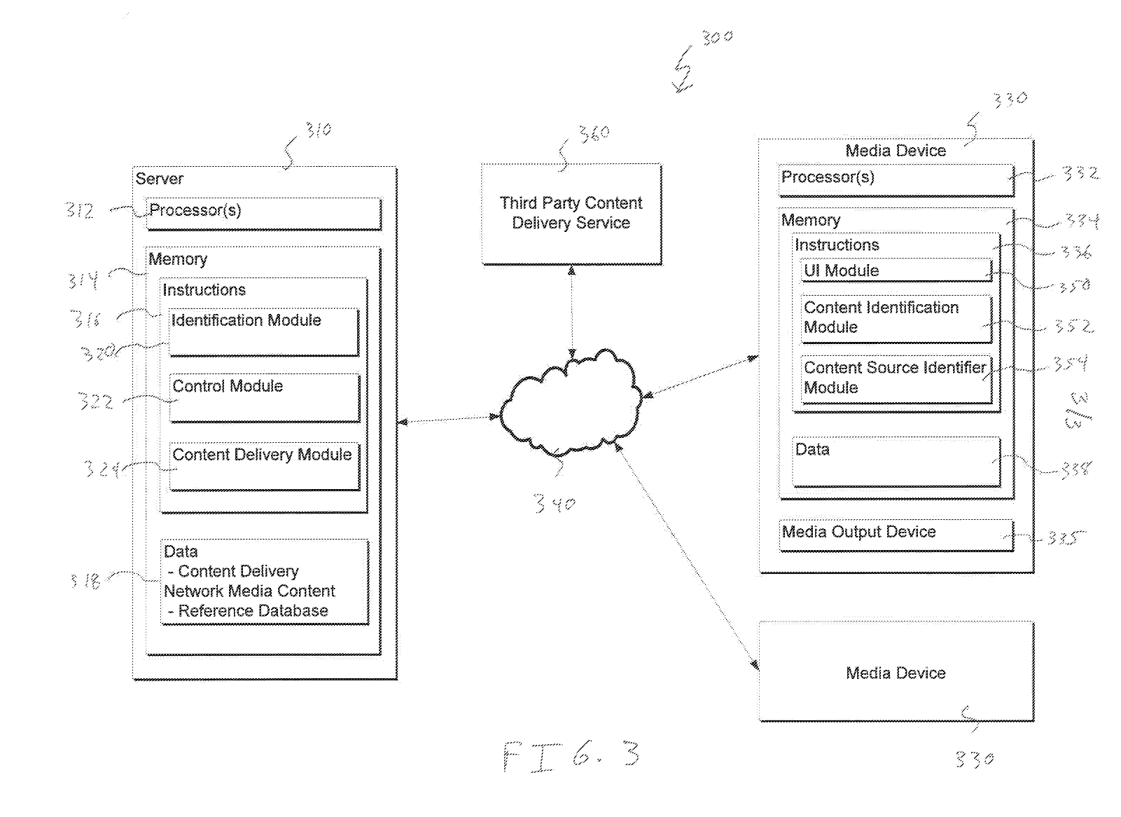

FIG. 2 depicts a flow diagram of an exemplary method 200 for providing synchronous playback of media content across a plurality of media devices. The method 200 can be implemented by one or more computing devices, such as the one or more computing devices depicted in FIG. 3. In addition, FIG. 2 depicts steps performed in a particular order for purposes of illustration and discussion. One of ordinary skill in the art, using the disclosures provided herein, will understand that various steps of any of the methods disclosed herein can be rearranged, omitted, modified, expanded, and/or adapted in various ways without deviating from the scope of the present disclosure.

At (202), the method includes identifying a plurality of media devices for synchronous playback. The plurality of media devices can be identified in any suitable manner. For instance, a user, via a suitable user interface, can create a group of media devices and add or delete media devices from the group. Alternatively and/or in addition, a group of media devices connected, for instance, via a network (e.g. the Internet), can be identified as a group of media devices for synchronous playback. In another implementation, a user can request to join a media device to a pre-existing group of a plurality of media devices for synchronous playback.

At (204), the method includes obtaining data indicative of media content on the plurality of media devices. For instance, a content identifier module implemented by the media devices can analyze the content stored locally on the media devices and accessible to the media devices via a network or other suitable link. The data indicative of media content on the plurality of media devices can be provided to a server and used to identify a media object (e.g. a song) that is suitable for synchronous playback across the plurality of media devices.

For instance, media content accessible to the media device can be identified. For instance, a local media library can be analyzed to identify media content stored locally on the media device. Identifiers for the local media content can be determined The identifiers can be determined using digital file metadata (e.g. the ID3 tag of an mp3 audio file), manual user tagging, or digital fingerprinting. The identifiers can be provided to a reference identifier database. The reference identifier database can include a set of global identifiers for media content that can be shared across a plurality of media devices, libraries, and content delivery services. The reference identifier database to determine global identifiers for the media content identified on the media devices. In one implementation, the reference identifier database can be associated with a content delivery service. The global identifiers can then be used, for instance, to identify remote media content accessible by the media devices from a remote library or content delivery service.

At (206), the method can include receiving a signal to play a media object. For instance, one of the media devices can receive a user input requesting to play a particular media object. The request to play the media object can be provided to a server. At (208), the method can include notifying the media devices to play the media object. For instance, the server can send a notification signal to each of the media devices in the group of the plurality of media devices to play the media content. The notification signal can include the global identifier for the media object determined, for instance, from the reference identifier database.

At (210), the media devices can identify an efficient content source to play the media content. The efficient content source for each media device can be determined based at least in part on the global identifier associated with media object. For instance, if a media device determines using the global identifier that it has access to a locally stored version of the media object, the media device can identify its local library of media content storing the media object as an efficient content source. If no local version is available, the media device can search remotely accessible libraries (e.g. libraries stored on remote computing devices or other media devices) using the global identifier to determine whether a remote version of the media object is accessible to the media device. If so, the remote library of media content storing the media object can be identified as an efficient content source. If the media object is not available via a local or a remote content source, the media device can determine based at least in part on the global identifier whether it has access to the media object via a third party content delivery service. If so, the third party content delivery (e.g. streaming) service can be identified as the content source.

If no version of the media object is accessible to the media device, the media device can send a request to a content delivery service for access to the song. For instance, a content delivery network can be associated with the server. The content delivery network can provide access to media objects that are synchronously playing across media device. The content delivery network can be identified as an efficient content source when the media device does not have access to the media object via a local or remote library or a third party content delivery service.

At (212), the method includes synchronizing playback of the media object across the media devices. The playback of the media object can by synchronized using, for instance, one or more control signals sent from a server. As discussed above, the server can be one of the plurality of media devices or a remote computing device such as a web server. The one or more control signals can control playback time of the media object across the plurality of media devices. For instance, the control signal can provide a reference time stamp for all media device to start playing media content. Other control parameters can be provided during synchronization, such as length of playback, stop times, etc.

In one implementation, synchronization can include identifying an additional media device joining the plurality of media devices during synchronous playback of a media object. A control signal can be sent to the additional media device to synchronize playback of the media object to a current play point of the media object across the plurality of media devices.

In another implementation, synchronization can include obtaining data indicative of a change associated with the media object (e.g. skipping tracks, pause, etc.) at one or more of the plurality of media devices. A control signal can be sent to the media devices to synchronize the requested change among the plurality of media devices.

### Example Computing Environment for Synchronizing Playback Among a Plurality of Media Devices

FIG. 3 depicts an example computing environment 300 for synchronizing playback among a plurality of media devices according to example embodiments of the present disclosure. FIG. 3 will be discussed with reference to a client-server architecture for purposes of illustration and discussion. One of ordinary skill in the art, using the disclosures provided herein, will understand that other suitable architectures can be used without deviating from the scope of the present disclosure.

The system 300 includes a server 310 and a plurality of media devices 330. The server 310 can communicate with the plurality of media devices 330 over the network 340. Although FIG. 3 depicts two media devices 330 in communication with the server 310, any number of media devices 330 can be in communication with the server 310 without deviating from the scope of the present disclosure.

The server 310 can include any suitable computing device. For instance, the server 310 can be a web server configured to implement a content delivery platform. Alternatively, the server 310 can be a media device. The server 310 can have a processor(s) 312 and a memory 314. The server 310 can also include a network interface used to communicate with one or more media devices 330 over the network 340. The network interface can include any suitable components for interfacing with one more networks, including for example, transmitters, receivers, ports, controllers, antennas, or other suitable components.

The processor(s) 312 can be any suitable processing device, such as a microprocessor, microcontroller, integrated circuit, or other suitable processing device. The memory 314 can include any suitable computer-readable medium or media, including, but not limited to, non-transitory computer-readable media, RAM, ROM, hard drives, flash drives, or other memory devices. The memory 314 can store information accessible by processor(s) 312, including instructions 316 that can be executed by processor(s) 312. The instructions 316 can be any set of instructions that when executed by the processor(s) 312, cause the processor(s) 312 to provide desired functionality. For instance, the instructions 316 can be executed by the processor(s) 312 to implement an identification module 320, a control module 322, and a content delivery module 324. For instance, the processor(s) can implement the identification module 320 to obtain data from the media devices 330 indicative of content accessible to the media devices 330.

Memory 314 can also include data 318 that can be retrieved, manipulated, created, or stored by processor(s) 312. The data 318 can include media content for a content delivery network implemented by the server. For instance, the data 318 can include a media library of media content that can be provided to media devices 330 upon request. The data 318 can further include a reference identifier database. The reference identifier database can be used to determine global identifiers for media content identified on media devices 330. The data 318 can be stored in one or more databases. The one or more databases can be connected to the server 310 by a high bandwidth LAN or WAN, or can also be connected to server 310 through network 340.

The server 310 can exchange data with one or more media devices 330 over the network 340. The media devices 330 can be any suitable type of device capable of consuming, processing, or playing media, such as a general purpose computer, special purpose computer, smartphone, tablet, digital music player, laptops, desktops, smart television, home theater systems or other suitable device capable of playing digital media.

Similar the computing device 310, a media device 330 can include a processor(s) 332 and a memory 334. The processor(s) 332 can include one or more central processing units and/or other processing devices. The memory 334 can store information accessible by processor(s) 332, including instructions 336 that can be executed by processor(s) 332 and data 338. For instance, the memory 334 can store instructions 336 for implementing a user interface module 350, a content identification module 352, and a content source identifier module 354. For instance, the UI module 350 can be used to implement a suitable user interface to allow a user of the media device 330 to interact with the system 300.

The media device 330 can include various input/output devices for providing and receiving information from a user, such as a touch screen, touch pad, data entry keys, speakers, and/or a microphone suitable for voice recognition. For instance, the media device 330 can include a media output device 338. The media output device 338 can include a display, an audio output device (e.g. speakers, headphones, radio transmitter), or other suitable media output device 338.

The client device 330 can also include a network interface used to communicate with one or more remote computing devices (e.g. server 310) or a computing device associated with a third party content delivery service 360 over the network 340. The network interface can include any suitable components for interfacing with one more networks, including for example, transmitters, receivers, ports, controllers, antennas, or other suitable components.

The network 340 can be can be any type of communications network, such as a local area network (e.g. intranet), wide area network (e.g. Internet), or some combination thereof. The network 340 can also include direct connections between any of the computing devices. In general, communication between the computing devices can be carried via a network interface using any type of wired and/or wireless connection, using a variety of communication protocols, encodings or formats, and/or protection schemes.

As illustrated in FIG. 3, one component of the system 300 is a content identifier module 350 for identifying content locally stored on the device. The content identifier module can be implemented by a media device 330 using a number of different techniques, or several techniques in conjunction for additional accuracy. These techniques can include, but are not limited to, use of digital file metadata (such as the ID3 tag of an mp3 audio file), manual user tagging, or digital fingerprinting technology. The identified local content can be matched against an identifier reference database (e.g. stored at the server 310) to identify one or more identifiers for the device content, so that all device content can be identified against both other device content, as well as content on an external system (e.g. third party content delivery service 360). In one implementation, the reference database can be included as part of data associated with a content delivery network implemented by the server 310.

Another component of the system 300 is the control module 322 for managing synchronization of media playback between the group of media devices 330. The control module 322 can be responsible for coordinating which piece of content to play on the media devices 330, and managing the playback time for each by use of a control signal (e.g. a timestamp). The control module 320 can handle additional devices joining the plurality of media devices 330, and synchronizing the additional devices to the current play point of the current media devices 330. Also when a change in the content is triggered (e.g. skipping to different point in playback, or to the next piece of content in a playlist), the control module 322 can propagate that change to all devices. The control module 322 can also handle additional interaction layers occurring during media playback, such as messaging and event notifications.

Another component of the system 300 is a content delivery module 324 configured to implement a content delivery network and provide specified media content on demand. Data associated with the content delivery network stored at the at the server 310 can also be used as a reference database (e.g. identifier reference database) for the identifying content on the media devices 330 in connection with the content identification module 350 implemented on the media devices 330. Additionally, the content delivery module 324 can interface with the control module 322 to deliver the requested content to media devices 330 that do not have access to a media object upon request.

Another component in the system 300 is the content source identifier module 354 configured to efficiently switch between local and remote content sources on the media device 330. Using control signals from the control module 322, the content source identifier module 354 can determine whether the content to be played should be pulled from its local storage, or streamed from a remote source. Additionally, the content source identifier module 354 can be required to resolve discrepancies between a local copy and the remote counterpart (such as a difference in the content duration or encoding quality.)

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM hard disk or optical or magnetic media.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

When data is obtained or accessed between a first and second computer system or component thereof, the actual data may travel between the systems directly or indirectly. For example, if a first computer accesses a file or data from a second computer, the access may involve one or more intermediary computers, proxies, and the like. The actual file or data may move between the computers, or one computer may provide a pointer or metafile that the other computer uses to access the actual data from a still further computer.

The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality complementary or unrelated to the present subject matter, as well. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, some embodiments of the methods and systems set forth herein may also be implemented by hard-wired logic or other circuitry, including, but not limited to application-specific circuits. Of course, combinations of computer-executed software and hard-wired logic or other circuitry may be suitable, as well.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for providing synchronous playback of media content across a plurality of media devices, comprising:
identifying, by one or more computing devices, a plurality of media devices for synchronous media playback;
identifying, by the one or more computing devices, a media object accessible by the plurality of media devices for synchronous playback;
notifying, by the one or more computing devices, each of the plurality of media devices to play the media object; and
synchronizing, by the one or more computing devices, playback of the media object among the plurality of media devices;
wherein each of the plurality of media devices is configured to identify a media content source for accessing the media object for synchronous playback of the media object.

2. The computer-implemented method of claim 1, wherein the plurality of media devices comprises a first media device and a second media device.

3. The computer-implemented method of claim 2, wherein a first media content source is identified for accessing the media object for synchronous playback on the first media device and a second media content source is selected for accessing the media object for synchronous playback on the second media device.

4. The computer-implemented method of claim 3, wherein the first media content source comprises a media library stored locally on the first media device and the second media content source comprises a media library stored on a remote device accessible by the second media device.

5. The computer-implemented method of claim 3, wherein the second media content source is part of a content delivery network implemented by the one or more computing devices.

6. The computer-implemented method of claim 1, wherein identifying, by the one or more computing devices, a media object accessible by the plurality of media devices for synchronous playback comprises:
obtaining data indicative of media content stored locally at or accessible by at least one the plurality of media devices;
obtaining one or more identifiers for the media content;
matching the one or more identifiers with a global identifier using a reference database.

7. The method of claim 6, wherein the one or more identifiers for the media content are determined based at least in part on digital metadata associated with the media content, user tags associated with the media content, or digital fingerprinting associated with the media content.

8. The method of claim 1, wherein synchronizing, by the one or more computing devices, playback of the media object among the plurality of devices comprises providing a control signal to the plurality of devices to control playback time of the media object.

9. The method of claim 1, wherein synchronizing, by the one or more computing devices, playback of the media object among the plurality of devices comprises:
identifying an additional device joining the plurality of devices during synchronous playback of the media object; and
synchronizing the additional device to a current play point of the media object.

10. The method of claim 1, wherein synchronizing, by the one or more computing devices, playback of the media object among the plurality of devices comprises:
obtaining data indicative of a change associated with the media object at one or more of the plurality of devices; and
synchronizing the change associated with the media object among the plurality of devices.

11. The method of claim 1, wherein the method comprises:
determining that the media object is not accessible by at least one of the plurality of media devices; and
providing the media object to the at least one of the plurality of media devices using a content delivery network implemented by the one or more computing devices.

12. The method of claim 1, wherein the one or more computing devices comprises one or more of the plurality of media devices.

13. The method of claim 1, wherein the one or more computing devices comprises a server accessible by the plurality of media devices.

14. A system for providing for providing synchronous playback of media content across a plurality of media devices, comprising:
one or more processors; and
one or more computer-readable media;
a content identifier module implemented by the one or more processors, the content identifier module configured to identify a media object accessible by one or more of a plurality of media devices;
a control module implemented by the one or more processors, the control module configured to notify each of the plurality of media devices to play the media object, the control module further configured to manage synchronization of playback of the media object across the plurality of media devices.

15. The system of claim 14, wherein the system comprises a reference database stored in the one or more computer-readable media, the content identifier module configured to identify a media object accessible by the plurality of media devices based at least in part on one or more identifiers stored in the reference database.

16. The system of claim 15, wherein the reference media library is part of a content delivery network.

17. The system of claim 13, wherein at least one of the plurality of media devices is configured to implement a media content source identifier module, the media content source identifier module configured to identify a media content source for accessing the media object.

18. A media device comprising:
a media output device; and
one or more tangible, non-transitory computer-readable media storing computer-readable instructions that when executed by one or more processors cause the one or more processors to perform operations, the operations comprising:
identifying a media object to be played synchronously with a remote media device;
notifying the remote media device to play the media object;
identifying a media content source for accessing the media object by the media device; and
synchronizing playback of the media object over at least the media output device among the media device and the remote media device.

19. The media device of claim 18, wherein the operation of identifying a media object to be played synchronously with the remote media device; comprises:
identifying media content stored locally at or accessible by the media device;
determining one or more identifiers for the media content; and
matching the one or more identifiers using a reference database to identify the media object for synchronous playback.

20. The media device of claim 18, wherein the operation of identifying a media content source for accessing the media object comprises identifying one of a local media content source, a remote media content source, or a content delivery service.
